(19) United States
(12) Patent Application Publication
(10) Pub. No.: US 2014/0047038 A1
(43) Pub. Date: Feb. 13, 2014

(54) METHOD AND SYSTEM FOR SENDING SCANNED DOCUMENTS TO MOBILE DEVICE USING OPERATOR'S NETWORK

(71) Applicants: Nischal M. Piratla, Hyderabad (IN); Kovendhan Ponnavaikko, Chennai (IN); Pratyush Prasanna, Bangalore (IN)

(72) Inventors: Nischal M. Piratla, Hyderabad (IN); Kovendhan Ponnavaikko, Chennai (IN); Pratyush Prasanna, Bangalore (IN)

(73) Assignee: XEROX CORPORATION, Norwalk, CT (US)

(21) Appl. No.: 13/568,128

(22) Filed: Aug. 7, 2012

(51) Int. Cl. G06F 15/16

(52) U.S. Cl. 709/206; 709/217

(57) ABSTRACT

The present disclosure discloses a method for utilizing a scanning device for sending scanned output to mobile devices. The method includes scanning one or more documents as input. The method further includes saving the scanned output in a pre-defined format. Thereafter, a phone number of a destination mobile device is received. Then, an operator associated with the phone number is identified. Finally, the scanned output is sent to the mobile device using the mobile device operator's network.

### TECHNICAL FIELD

Broadly, the presently disclosed embodiments relate to scanner or multi-function devices, more particularly, to methods and systems for sending scanned documents to mobile devices.

### BACKGROUND

Scan to PC is a way of sending scanned documents to Personal Computers (PC) in a computer network, for example, Local Area Network (LAN). For scanning purposes, a standalone scanner or multi-function device (MFD) incorporating the functionalities of one or more of printing, scanning, faxing and copying can be used. The scanning device as well as the PC needs to be a part of the same LAN. As a standard process, the user first inputs one or more documents for scanning and then provides his email address to which the scanned documents are to be sent. Finally, the scanned documents are sent to the desired email address. In this approach, the scanning device needs to know Internet Protocol (IP) address of the PC or vice versa and thus, this is more of an IP based approach.

Similar to the above, Scan to Mobile technology has been addressed and implemented. Here, the scanning device is connected to a scan application running on a mobile phone via USB, Wi-Fi or other networks. The scan application on the mobile phone then receives the scanned documents from the scanning device over the created local LAN. In this approach too, the mobile device has to know the IP address of the scanning device or vice versa. Along with this, the mobile phone has to have an instance of a scan application running on it and further needs to have the Internet connection for receiving the scanned documents. In view of the continuing challenges, there exists a need of methods and systems for sending scanned documents to mobile phones in a more convenient way.

### SUMMARY

The present disclosure discloses a method for utilizing a scanning device for sending scanned output to mobile devices. The method includes scanning one or more documents as input. The method further includes saving the scanned output in a pre-defined format. Thereafter, a phone number of a destination mobile device is received. Then, an operator associated with the phone number is identified. Finally, the scanned output is sent to the mobile device using the mobile device operator's network.

Further, the disclosure describes a system for sending one or more scanned documents to mobile devices. The system includes a scanning module configured to scan one or more documents as input. The system further includes a local storage module configured to store the scanned output in a pre-defined format. Further, the system includes a scan to mobile application that is configured to receive a phone number of a mobile device to which the scanned output is to be sent. The scan to mobile application is further configured to identify an operator associated with the received phone number. Additionally, the system includes a network interface configured to send the scanned output to the mobile device using the mobile device operator's network.

Additional embodiments disclose a system for sending one or more scanned documents to mobile devices. The system includes a scanner configured to scan one or more documents as input by a user and to generate a scanned output. The system further includes a scan to mobile application that is configured to receive a phone number of a mobile device to which the scanned output is to be sent. The scan to mobile application is also configured to identify an operator associated with the received phone number. Moreover, the system includes a cellular interface having cellular information that is configured to send the scanned output to the mobile device as Multimedia Messaging Service (MMS) or Short Messaging Service (SMS) using the mobile device operator's network.

### BRIEF DESCRIPTION OF THE DRAWINGS

FIG. 1 illustrates an exemplary embodiment of the present disclosure.

FIG. 2 is a method flow chart illustrating a process for sending scanned documents to mobile devices.

FIGS. 3A and 3B represent block diagrams illustrating interaction among various components for sending scanned documents to mobile devices.

FIG. 4A is an exemplary user interface snapshot of scan to mobile application.

FIG. 4B is a screenshot displaying SMS received as a web link on a mobile device.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### Definitions

In various embodiments of the disclosure, definitions of one or more terms that will be used in the document are given below. The “scanning module” is a device or a program configured to scan one or more documents as input by a user. The scanning module is capable of receiving an input, capturing an image, and optionally displaying an output. The scanning module can be configured to perform additional functionalities related to printing, copying, or the like. Further, the “scanned output” refers to an output generated after scanning the documents, which may be any image file format including PDF file format. A “scan to mobile” application is software running on the scanning module enabling sending of scanned output to mobile devices using the mobile device operator's network. The “mobile device” refers to any computing device capable of receiving data from other computing devices, scanning module or so on. The mobile device is also capable of processing and displaying information. The term “mail server” includes a program or device capable of sending or receiving email messages from one user to another. The phrase “number to operator translator” refers to any program/application or device capable of translating a given phone number into an associated operator's information. “EmailtoSMS” gateway refers to a device that receives emails and sends that email as text message to a destination mobile device. In similar manner, “EmailtoMMS” gateway is a device that receives emails and sends that email as multimedia message (that includes text, pictures, or audio) to a destination mobile device.

### Overview

Broadly, the disclosure relates to scanning or multi-function devices. In particular, the disclosure utilizes these devices for sending one or more scanned documents to mobile devices using telecommunication operator's network. The scanned documents may be in the form of a PDF or an image file. These scanned documents are sent to the mobile devices based on phone number information. Further, the scanned documents are sent to the mobile devices as Multimedia Messaging Service (MMS) or Short Messaging Service (SMS). The SMS or MMS are sent through control channels, which actually form a part of the voice channel.

Various examples of the mobile devices include mobile phones, smart phones, Personal Digital Assistants (PDAs), Pagers, Enterprise Digital Assistants (EDAs), or iPads. For sending the scanned documents to a mobile device, the mobile device does not need to have a scan application running on it. Further, the mobile device does not need to have a data tariff or Internet connection to receive the scanned documents as MMS or SMS. The mobile device can be a simple passive device receiving communication, in a manner similar to receiving a call or SMS.

### Exemplary Embodiment

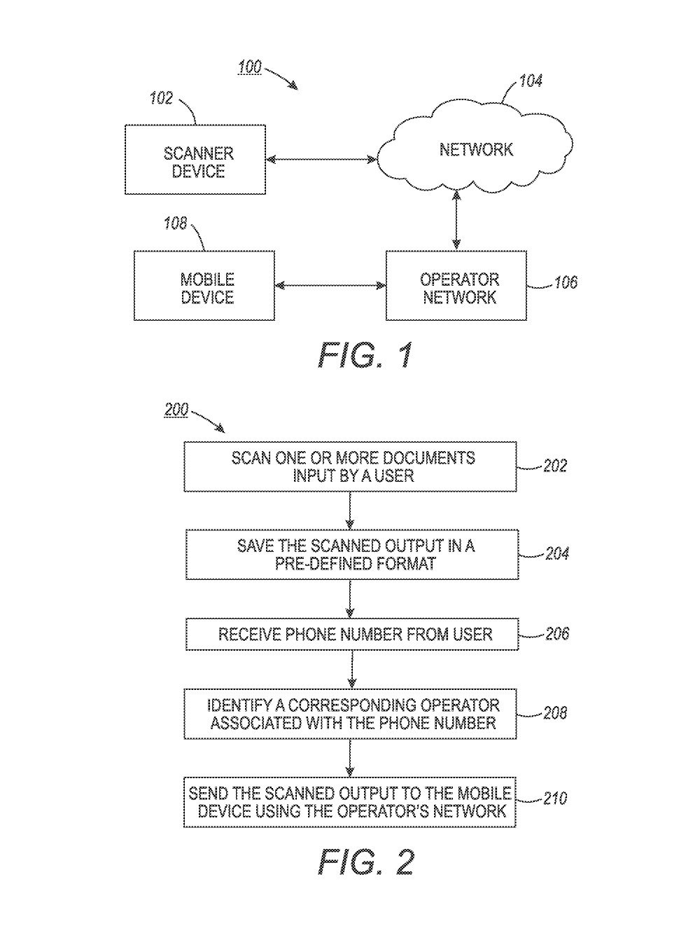

FIG. 1 illustrates an overall exemplary system 100 of the disclosure. The system 100 includes a scanning device 102, a network 104, a mobile device operator's network 106 (which, for convenience, will be referred to as an operator's network), and mobile device 108. Each of the shown components communicates with the others via conventional network protocols and the components will be described in the following sections.

The scanning device 102 does conventional functions of scanning one or more documents and may include other functional and structural details that are not relevant for purposes of the present disclosure and will not be described in further detail here. The scanned documents can be saved in a PDF format or an image file; these formats can be pre-defined according to user's preferences. In the context of the present disclosure, the scanning device 102 is configured to send the scanned output to the mobile device 108 using the operator's network 106. In particular, in the present embodiment, the scanned documents are sent to mobile devices directly from the scanning device 102, with simple knowledge of phone numbers. In some embodiments, the scanning device 102 can be replaced by a multi-functional device that is capable of scanning as well as printing, copying, or performing other functionalities as desired.

As shown, the network 104, which in this embodiment includes the Internet, connects the scanning device 102 to the operator's network 106. According to one embodiment of the disclosure, the network 104 may be wired or wireless. Network 104 includes all types of conventional wired or wireless networks. Various examples of such networks include, but not limited to, Local Area Network (LAN), Wide Area Network (WAN), a Metropolitan Area Network (MAN), Wireless LAN, and so forth. The operator's network 106 typically includes a local, regional, or global communication network such as an enterprise telecommunication network, a global mobile communication network, or any combination of similar systems.

Through the operator's network 106, the scanned documents are sent to the mobile device 108. The mobile device 108 is the one that receives the scanned document from the scanning device 102. The scanned document is received in the form of MMS or SMS and this does not require having any kind of Internet connection or scan application running on it. In cases where the scanned output is sent as SMS, a web link is sent to the mobile device 108 and the scanned output can be retrieved by opening the web link. The web link can be accessed in a manner similar to as known in the art.

### Exemplary Flowchart

In existing scan to mobile solutions, users need to access emails or need to have Internet connection, or a scan application onto his or her device and this unnecessarily increases burden on the users. In some areas, especially, rural areas, people do not have access to emails or the Internet even though the user might have a mobile device (not necessarily a smart phone) and people generally prefer receiving communication on his or her mobile device and without requiring a data connection. Keeping the above challenges and preferences in mind, the disclosure provides a solution where receiving scanned documents on mobile devices is possible without having Internet connection or any software running on the device.

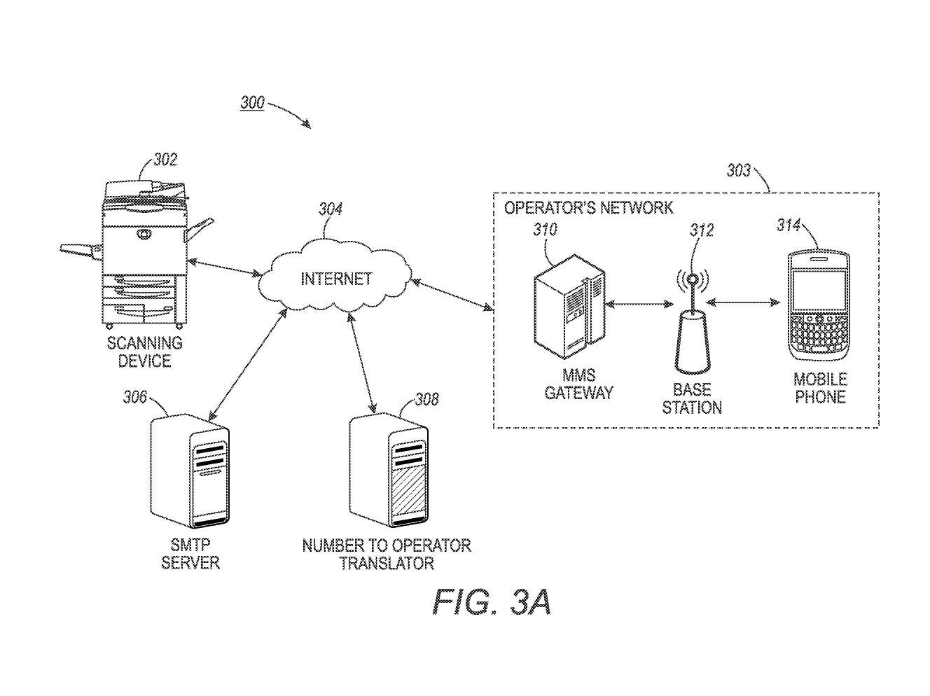

FIG. 2 is a flowchart for sending scanned documents to mobile devices. Particularly, the method utilizes a scanner or equivalent device for sending the scanned documents to the destination mobile device. The user may wish to receive scanned output on his device or may wish to send the scanned output to his grandmother, for example. Accordingly, the destination mobile device may be the user's device or may belong to his or her friends, relatives, or other third parties.

The method begins with scanning one or more documents as input by a user, at 202. The documents can be application forms, photos, supporting documents, such as, PAN card, drivers license, passport, or the like. After scanning, the image is saved in a format including PDF file or other image file format, at 204. This format may be pre-set by the user or may be a default format as set by an administrator. After scanning, the user selects the scan to mobile application for sending the scanned document to the mobile device. The scan to mobile application is then loaded and initiated automatically on the scanning device 102.

Thereafter, the scan to mobile application prompts the user to input a destination phone number to which she wishes to send the scanned documents. The user inputs the number, which is received by the scan to mobile application at 206. Along with this, the user provides the information whether she wishes to send scanned output as SMS or MMS to the mobile device. Alternatively, the scan to mobile application sends the scanned output according to default settings. For example, if the scan to mobile application is configured to send SMS by default, then SMS is sent. But if the application has MMS as a default setting, then the scanned output is sent as MMS to the mobile device. In still other embodiments, the scanned output is sent as SMS or MMS based on whether the operator/carrier provides functionality related to MMS gateway or not. For example, some carriers may not support MMS functionality, in which case the scanned output is sent as SMS using SMS gateway. Thus, the scanned output is sent as SMS or MMS based on whether the destination mobile device supports MMS functionality. For example, iPhone does not support receiving MMS, and the scanned output is therefore sent as SMS through SMS gateway. Based on various scenarios as discussed, the system 100 decides whether the scanned output needs to be sent as SMS or MMS. In additional embodiments, when the carrier does not provide MMS gateway, then an enterprise may have its own MMS gateway to support MMS functionality. Accordingly, the scanned output can be sent as MMS.

Once the scan to mobile application receives the desired input from the user, the scan to mobile application identifies the operator associated with the phone number, at 208. For example, if the received phone number is 650-450-6511, the scan to mobile application identifies that the input phone number belongs to Verizon operator. To identify the operator's information, the scanning device 102 may have a local storage module that stores a list of phone numbers and associated operators. Alternatively, user may provide the operator information, or the scanning device 102 may retrieve operator's information from a third party databases, or the like. After identifying the operator's information, at 210, the scanned output is sent to the mobile device as MMS or to a web server and then notifying the user of the web link by SMS using operator's network, details of which will be covered below.

In one embodiment, the scanning device 102 incorporates cellular interface functionality. This means that the scanning device 102 has cellular information in terms of sim card and phone number, and is capable of sending the scanned output to the destination mobile device in a manner that is similar to sending SMS messages or MMS between mobile devices.

In other embodiments, the scanning device 102 is connected to the Internet via Ethernet or WiFi and sends the scanned output as an email. Insofar as the service provider or carrier provides an MMS carrier, the scanned output is sent as MMS to the mobile device. The scanned output is sent as an email using an SMTP server to the MMS gateway of the identified operator/carrier as stated in the format listed by the operator for email2MMS functionality. For example, some email2MMS formats for large US operators/carriers are: Verizon US: ‘xxxx@vzwpix.com’; AT&T US: ‘xxxx@mms.att.net’; T-Mobile US: ‘xxxx@tmomail.net’. Thus, for example, if the phone number is 650-450-6511 and belongs to a Verizon operator then scanned the output is transmitted as an email to 6504506511@vzwpix.com.

In the absence of an MMS carrier , the system 100 uses email to SMS technology. In such cases, the scanned output is stored on a web server and the weblink is then sent as an email using SMTP server to the SMS gateway of the identified operator/carrier as stated in the format listed by the operator for email to SMS functionality. For example, the email to SMS formats for two large US operators/carriers are: Verizon US: ‘xxxx@vtext.com’, and AT&T US: ‘xxxx@txt.att.net’. Thus, for example if phone number 650-450-6511 belongs to a Verizon operator, then a weblink to the scanned output is sent as an email to 6504506511@vtext.com.

Once the scanned output is received on the mobile device, the scanned output can be utilized in any manner desired. For example, the scanned output may be printed via mobile printing technology as is known. In another example, the information included in the scanned output can be utilized for verification purposes.

To one of ordinary skill in the art, it will be clear that the steps can be implemented in any order desired and need not necessarily be implemented in the same order as discussed above.

Exemplary Application

One exemplary usage of the disclosure will be discussed, and for a person skilled in the art, it is understood that the example is not intended to limit the scope of the disclosure. A user may wish to open a savings account with a Bank “ABC”. As a conventional process, the user fills out the application form and needs to submit one or more supporting documents—PAN card, drivers license, or passport. Assuming the user forgets to submit the PAN card and subsequently wants to send the PAN card to the bank representative. Using a system of the present disclosure, the user can scan the PAN card using the scanning device 102 and input the phone number of the bank representative through the scanning device 102. The user can also specify if he wishes to send the scanned PAN card to the bank representative as SMS or MMS or the system may decide to send as SMS if it determines that there carrier does not provide an MMS gateway. Based on this information, the scanning device 102 sends the scanned output to the destination mobile device. If the scanning device 102 has cellular functionality, then the scanning device 102 can send the scanned output as SMS or MMS directly as discussed above. If the scanning device 102 does not have the cellular functionality but is connected to the Internet via Wi-Fi, Ethernet or other modes, then the scanning device 102 first identifies the email address of the associated operator and inserts phone number in that identifies email address. So if 6504506511 is the phone number, and AT&T is the identified operator with retrieved email address of xxxx@txt.tt.net, then the scanned output is sent as email to 650450651@txt.att.net from the mail server to the SMS gateway. The SMS gateway then forwards the scanned output as SMS to the mobile device of the bank representative. The bank representative can utilize the received scanned output to verify the details included in the application form as earlier filled by the user, with the PAN card information and accordingly proceed further.

### Exemplary System

Considering the increasing travelling workforce in today's time, the disclosure provides a way of sending or receiving the scanned output to mobile devices without requiring the devices to make use of a data channel and thereby avoid incurring data tariffs, and without requiring scan software.

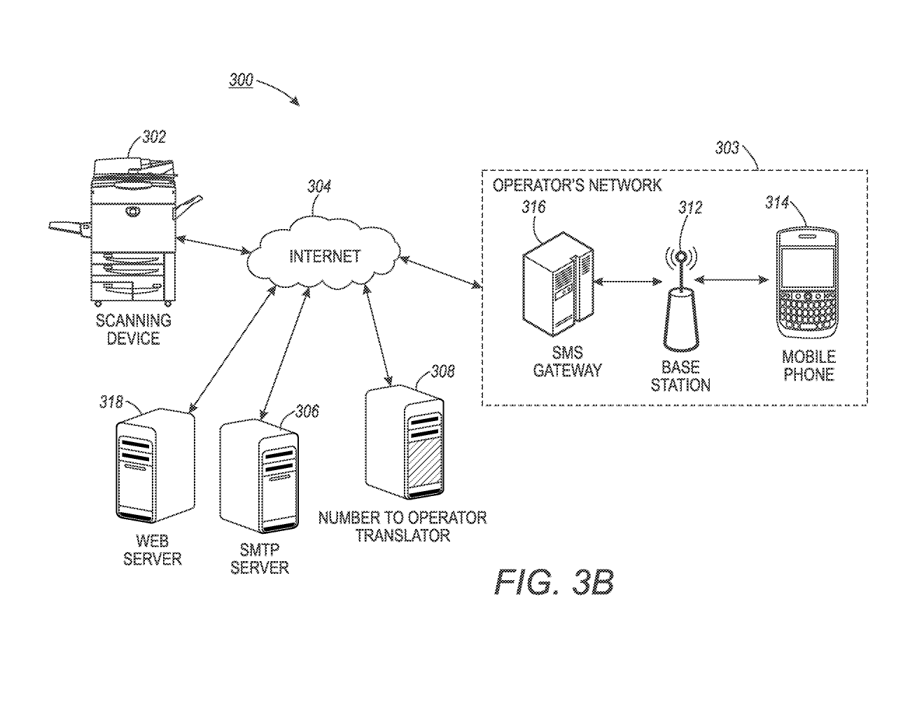

FIG. 3 discloses a system 300 including a scanning device 302, the Internet 304, and an operator's network 303. As shown, the operator's network 303 includes a gateway, particularly, MMS gateway 310, a base station 312 and a destination mobile device 314. The scanning device 302 is connected to the operator's network 303 through the Internet 304. The system of FIG. 1 also includes an SMTP server 306, and a number to operator translator 308. Each of the shown components interacts with others using known protocols.

The scanning device 302 is a device that scans documents. In particular, the scanning device 302 scans one or more documents and generates the scanned document data (referred to as scanned output) in the form of a PDF file or an image file. To support this feature, the scanning device 302 includes a platen on which the user places the document to be scanned and then presses the scan button. After this, the scanned image is saved in the scanning device memory (not shown) either as PDF or image file. According to the present disclosure, the scanning device 302 further includes an application or software running on it and a user interface. The user interface receives input from the user and displays information/output to the user. The software enables the user to send the scanned image to the mobile device 314.

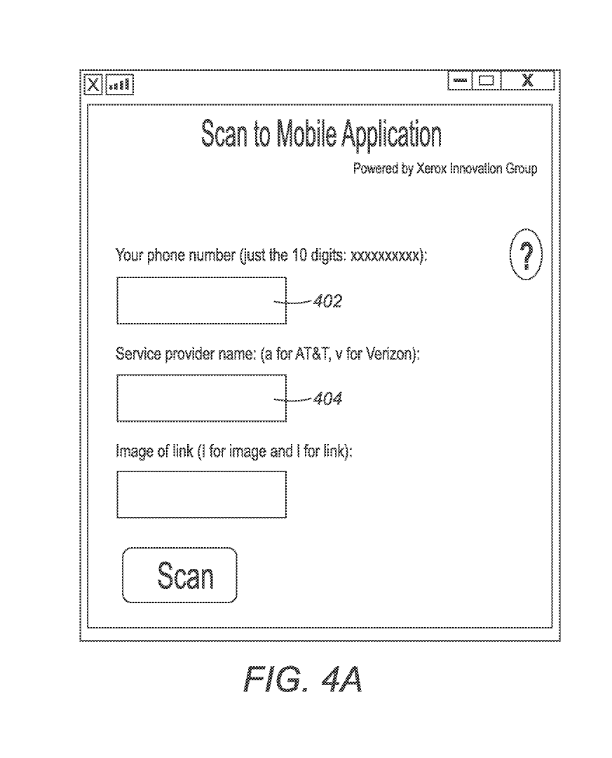

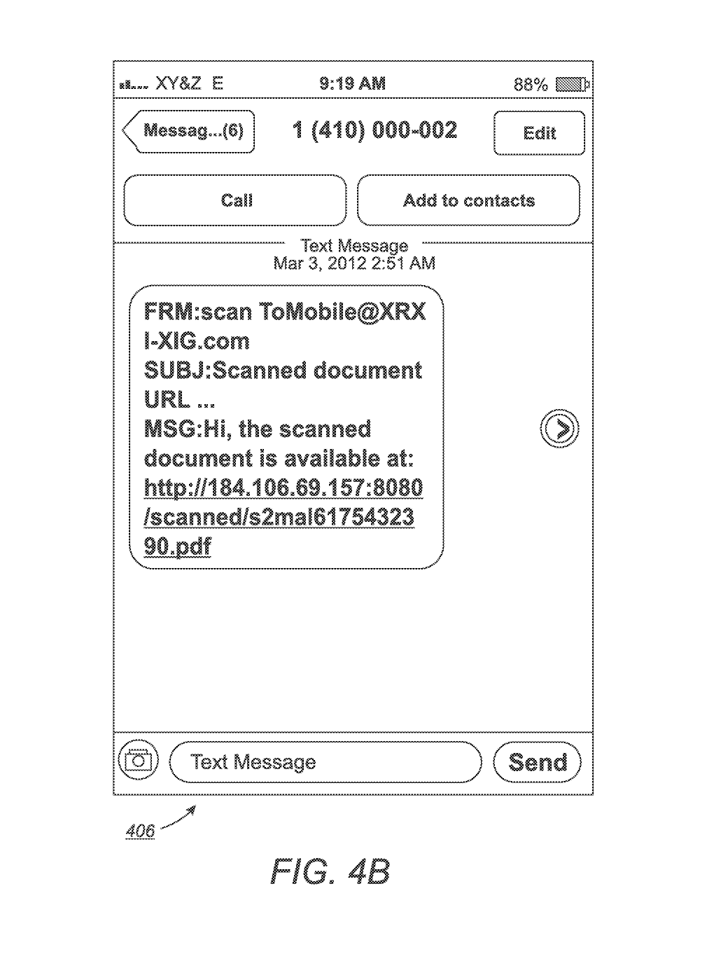

The scanning device 302 initiates the scan to mobile application after completing the scanning activity. The scan to mobile application then prompts the user to input the phone number. As shown in the FIG. 4A, the user can provide the phone number in the given text box, marked as, 402. Once the user inputs the phone number, the scan to mobile application identifies the operator associated with the phone number. In one embodiment, the scanning device 302 may have a local storage module that stores the mapping of a plurality of phone numbers to the corresponding operator information, while in some embodiments, the operator associated with the phone number may be obtained from a third party databases through application program interface (API). Still in some cases, the user may provide the operator's information in the text box 404 of FIG. 4A.

After identifying the operator's information, the scanned output is sent to the mobile device 314 either through a cellular interface functionality or other network interface.

In this embodiment, the scanning device 302 has a cellular interface (although not shown) for sending the scanned output to the mobile device 314. The cellular interface provides cellular data connectivity. To facilitate cellular connectivity, the cellular interface has a cellular port and a cellular card. The cellular card stores the telephone number assigned to the scanning device 302 on appropriate storage means (not shown). Further, the cellular card may employ hardware, software, and firmware, imparting cellular functionality to scanning device 302. Additionally, cellular card can employ a cellular modem via which the scanning device 302 can be accessed. Such cellular components are known to those in the art and thus need not be described in detail here. It is to be appreciated and understood that cellular components need not reside inside the scanning device 302. Some of the components that impart cellular functionality can be configured externally to the scanning device 302. The cellular interface may also include a cellular antenna (not shown) to detect cellular signals and transmit information when required.

The cellular interface may include any known cellular technology, such as global system of mobile communication (GSM), code division multiple access (CDMA), wideband CDMA (WCDMA), Time Division Synchronous CDMA (TD-SCDMA), and so on. It will be understood that any known or future developed telecommunication technology may be utilized to provide cellular connectivity. In case of GSM technology, the cellular card may be a Subscriber Identity module (SIM card). A GSM-enabled scanning device may communicate with devices in a remote location, such as a cell phone, using voice or SMS services.

Using the cellular interface, the scanned output is sent to the mobile device 314 as MMS or SMS using operator's network 303. This will be same as one mobile device 314 sending MMS or SMS to other mobile device and thus details related to this technology need not be describe here. If the scanned output needs to be sent as SMS, the scanned output or image is saved on a web server and the cellular interface of the scanning device 302 communicates with SMS gateway 316 as shown in FIG. 3B. The SMS gateway 316 then communicates with the base station 312 nearest to the mobile device location and sends the web link as SMS to the destination mobile device 314. But if the scanned output needs to be sent as MMS, then the cellular interface interacts with the MMS gateway 310 for sending the scanned output as MMS to the destination mobile device 314. In case of cellular interface, the shown components such as SMTP server 306, number to operator translator 308, Internet 304 are not required for implementation purposes.

As discussed above, the scanning device 302 decides whether the scanned output needs to be sent as SMS or MMS. For example, if the user provides input as MMS for sending the scanned output, and further the scanning device 102 determines that the identified operator does not support MMS functionalities, then the scanning device 102 will save the output or image on a web server and send the link to the image as SMS, but if the identified operator supports MMS features, then scanned output is sent as MMS.

In other embodiments, the scanning device 302 is connected to the Internet via network interfaces such as, Wi-Fi, or Ethernet. In such cases, the scanning device 302 is connected to SMTP server 306 and, number to operator translator 308. In the shown embodiment, the scanning device 302 retrieves the operator's information of the received phone number from the number to operator translator 308. After identifying or retrieving the operator's information, the scanning device 302 identifies an email address format corresponding to the identified operator. The email address can be obtained from the number to operator translator 308 or may be stored in the local storage module of the scanning device 302. The email address is further identified based on whether the scanned output needs to be sent as SMS or MMS. For instance, if the operator is AT & T and scanned output needs to be sent as SMS, then the email address for this operator may be ‘xxxx@txt.att.net’ but if the scanned output needs to be sent as MMS for the same operator, then the email address may be ‘xxxx@mms.att.net’. But if the operator is T Mobile, and the scanned output needs to be sent as MMS, then the email address may be ‘xxxx@tmomail.net’. Such email addresses are advertised by operator's on their websites.

In some embodiments, the scanning device 302 interacts with number to operator translator 308 for operator's information as well as the associated email address. Once received, the scanning device 302 may verify the information stored in its local storage module.

After identifying the appropriate email address, the scanning device 302 inserts the phone number in that address. Then, the scanning device 302 sends the scanned output and email address information to the SMTP server 306. The SMTP server 306 is configured to send the received information in the form of an email to the gateway. If the email needs to be sent as the MMS, then the SMTP server 306 sends the information to MMS gateway 310 (also referred to as emailtoMMS gateway). On the other hand, if the email needs to be sent as SMS, then the information is sent to the SMS gateway 316 or emailtoSMS gateway. The emailtoMMS or emailtoSMS gateway converts the received email into MMS or SMS format, respectively and sends it to the base station 312 nearest to the destination mobile device 314. The base station 312 then sends the MMS or SMS to the destination mobile phone 314.

In this embodiment, details related to sending the scanned output when using SMS are described. The scanned output is saved on a web server and an SMS is sent in the form of a web link to the mobile device 314. To explain, the scanning device 302 saves the scanned output on the web server 318 and creates a web link for accessing output stored on that web server 318. Subsequently, the web link and email address information are sent to the SMTP server 306. The SMTP server sends the email to the SMS gateway 316, which then finally sends the web link to the destination mobile device 314. One exemplary screenshot 406 of the scanned output received as a web link on the mobile is shown in FIG. 4B. Once received, a user of the mobile device can click the web link and can download the scanned output from the web server on the mobile device 314. One benefit of sending the scanned output as SMS is that the web link can be accessed anytime from anywhere.

In some embodiments, functionalities related to SMTP server 306 and number to operator translator 308 can be incorporated into the scanning device 302, and thus, a single unit can be formulated.

The present disclosure discloses methods and systems for sending scanned output or documents to a mobile device using telecommunication operator's network and has many advantages. The scanned document is sent as MMS or SMS to the mobile device, the mobile device here need not necessarily be a smart device. The mobile device to which the scanned document is sent does not require an Internet connection for receiving the scanned document. Further, the mobile device does not need to be on the same network as the scanning device. Moreover, the mobile device does not need to have a scan application running on it. Additionally, the received scanned output can be further forwarded to any mobile device.

What is claimed is:

1. A method of utilizing a scanning device for sending scanned output to mobile devices, comprising:
scanning one or more documents as input;
saving the scanned output in a pre-defined format;
receiving a phone number of a destination mobile device;
identifying a corresponding operator associated with the phone number; and
sending the scanned output to the mobile device using a mobile device operator's network.

2. The method of claim 1 further comprising initiating a scan to mobile application on the scanning device.

3. The method of claim 1, wherein the pre-defined format includes any image file format.

4. The method of claim 1, wherein identification includes translating the received phone number into operator information.

5. The method of claim 1, wherein the scanned output is sent to the mobile device as a Multimedia Messaging Service (MMS) or Short Messaging Service (SMS).

6. The method of claim 5 further comprising sending the scanned output as an email.

7. The method of claim 6 further comprising identifying an email address format corresponding to the identified operator.

8. The method of claim 7, wherein the email address format is further identified based on whether the scanned output is sent as MMS or SMS.

9. The method of claim 8 further comprising inserting the phone number in the identified email address format or generating an email address based on the phone number.

10. The method of claim 9 further comprising sending the email using a mail server to the operator's gateway.

11. The method of claim 10, wherein the operator's gateway includes emailtoSMS or emailtoMMS gateway.

12. The method of claim 5, wherein the scanned output as SMS is sent as a web link to the mobile device.

13. The method of claim 12, wherein the web link is stored on a web server.

14. A system configured for sending one or more scanned documents to mobile devices, the system comprising:
a scanning module configured to scan one or more documents as input;
a local storage module configured to store the scanned output in a pre-defined format;
a scan to mobile application configured to:
receive a phone number of a mobile device to which the scanned output is to be sent; and
identify an operator associated with the received phone number; and
a network interface configured to send the scanned output to the mobile device using the mobile device operator's network.

15. The system of claim 14, wherein the pre-defined format includes any image file format.

16. The system of claim 14, wherein the local storage module maintains a list including mapping of a plurality of phone numbers to operator information.

17. The system of claim 14, wherein the scanning module is configured to send the scanned output by Multimedia Messaging Service (MMS) or Short Messaging Service (SMS).

18. The system of claim 17 further comprising a cellular interface for sending the scanned output as a new MMS or SMS to the mobile device.

19. The system of claim 17 further comprising a mail server configured to send the scanned output as an email to mobile device operator's gateway.

20. The system of claim 19, wherein the mobile device operator's gateway includes emailtoMMS and emailtoSMS gateway.

21. The system of claim 20, wherein the scanning module is configured for generating an email address based on the phone number of the mobile device.

22. The system of claim 17, wherein the SMS is stored as a web link on a web server.

23. A system for sending one or more scanned documents to mobile devices, the system comprising:
a scanner configured to scan one or more documents as input by a user and to generate a scanned output;
a scan to mobile application configured to:
receive a phone number of a mobile device to which the scanned output is to be sent; and
identify an operator associated with the received phone number; and
a cellular interface having cellular information that is configured to send the scanned output to the mobile device as Multimedia Messaging Service (MMS) or Short Messaging Service (SMS) using the mobile device operator's network.

24. The system of claim 23 further comprising a local storage module configured to store the scanned output in a pre-defined format, and a list having a mapping of a plurality phone numbers to operator information.
